(19) United States
(12) Patent Application Publication
(10) Pub. No.: US 2006/0208559 A1
(43) Pub. Date: Sep. 21, 2006

(54) Wheel ornament assembly as constantly vertical for rotationally independant wheel spinner

(76) Inventor: Bruce Elliott Morris, Spokane, WA (US)

Correspondence Address: Bruce Morris, E.4103 Rich, Spokane, WA, 99217, US

(21) Appl. No.: 11/083,149

(22) Filed: Mar. 17, 2005

(51) Int. Cl. B60B 7/04

(52) U.S. Cl. 301/37.25

(57) ABSTRACT

The objective of the present inventionis to implement an ornamental device including; a spindle adapter (30) established in the centemost portion of a rotationally independant wheel spinner assembly of a wheel; and a ornamental member (24) consisting of an aesthetic feature casted thereupon and axially joining with rotationally independant wheel spinner and encompassing a counterbalance (34); whereby upon wheel rotation to coordinately revolve spindle adapter (30) fixed on spinner assembly, the ornamental member will be situated vertically consistently relative to the rotation of combined car wheel and spinner assembly to thereby display the aesthetic ornament vertically, plainly, and perceivably.

### CROSS-REFERENCE TO RELATED APPLICATIONS

Not Applicable

### SEQUENCE LISTING PROGRAM

Not Applicable

### BACKGROUND OF THE INVENTION--FIELD OF INVENTION

The present invention typically related to wheel ornaments, distinctly to a wheel ornament that is non-rotatable relative to wheel and rotationally independant wheel spinner speed.

### BACKGROUND OF THE INVENTION--PRIOR ART

Originally, vehicle wheels contained assemblies that utilized a bearing assembly to fully disengage wheel rotation from a fixed wheel cover, such as may be beneficial when that cover carries advertisement displays or other information, that in order to be readable outside the vehicle, needs to be stationary when the vehicle is in motion. U.S. Pat. 3,722,958 (1973) to Marshall discloses a rotatable wheel cover 10 supported by an extending shaft 94 containg a bearing assembly and is attachable to any automobile wheel hub or lug nuts however, it utilizes a disc or cover, thereby comsuming the opening of the wheel. U.S. Pat. No. 5,659,958 (1973) to Hsiao comprises an entire wheel cover 28 mounted to display indicia thereon while remaining non-rotatable upon wheel rotation by a stabilizing structure configured to operate in correlation with a counter weight. U.S. Pat. No. 5,588,715 (1996) to Harlen discloses a non-rotating wheel cover assembly including a hardware 40 for mounting the wheel cover directly to a vehicle wheel allowing non-rotational support during rotation of the wheel. U.S. Pat. No. 4,929,030 (1990) to Park discloses a stationary member on an automobile hub cap containing a static lateral axis 24 supported by a bearing 14 and a bushing 17 located at the center of the axis, permitting continuous observability upon wheel rotation however, it utilizes a disc or cover U.S. Pat. No. 5,957,542 (1999) to Boothe shows a theft-proof non-rotating wheel cover with replaceable ornament containing a base 4 which supports the device within a central cavity in an automotive wheel. A cover plate 10 is mounted with a bearing 3 and a weight 9 to restrict rotational motion during the rotation of the wheel axis. And U.S. Pat. No. 6,848,751 (2005) to Yuan also discloses a non-rotational emblem apparatus as constantly upright-oriented on wheel disc comprising a housing placed in the main axial portion of a-wheel disc of an automotive wheel includes an ornamental feature or logo bearing a uniform pendulum weight in the lower proximity acting as an anti-rotation mechanism, so that, as a wheel of a car rotates it will always remain in an upright position relative to wheel rotation to continuously display the ornament attached however, the emblem is place upon a cover. U.S. Pat. No. 6,554,370 (2003) to Fowlkes shows a unique invention comprising a rotationally independant wheel spinner that utilizes a bearing assembly to fully decouple wheel rotation from the wheel spinner, such as may be desirable when that spinner rotates at a different rotational speed, than the speed of the wheel. FIG. 2 shows a spinner 30 that recieves a spinner mount 18 which contains a receptacle 48 that allows a cap 44 containing a threaded section 46. Thus, when wheel 12 stops, cap 44 also comes to a stop, thereby making any logos on the cap 44 readable, but nevertheless all rotationally independant wheel spinners heretofore known suffer from a considerable disadvantage:
(a) Although independant rotation of spinner assembly 70 was achieved by utilizing a bearing assembly, his invention failed to take advantage of an additional bearing assembly by constructing the spinner mount (18) FIG. 2 to recieve a spindle adapter to support the additional bearing assembly, contrary to a stationary cap (44), such as to fully decouple a decoratively formed ornament from the corresponding vehicle wheel and spinner assembly, thereby making the ornament non-rotatable.

In conclusion, Insofar as I am aware, no procedure has been conceived that exploits the graceful optical effect that will manifest, if the rotationally independant wheel spinner utilized a spindle adapter to support an additional bearing assembly, to continuosly display a decoratively formed ornament including an; image, logo, trademark, famous brand, personal favorite, design, word, letter, number, or figure.

### BACKGROUND OF INVENTION--OBJECTS AND ADVANTAGES

Accordingly several objects and advantages of the invention are:
(a) To provide a non-rotatable wheel ornament for a rotationally independant wheel spinner that utilizes tamper-proof screws making theft difficult.
(b) To provide a non-rotatable wheel ornament for a rotationally independant wheel spinner that comprises a bearing assembly admitting it the ability to remain non-rotatable relative to a combined corresponding wheel and rotationally independant wheel spinner.
(c) To provide a non-rotatable wheel ornament that performs a graceful function, that is not only optically pleasurable to the owner or observer outside the vehicle, but also rewards the creator with the gratification of knowing that the time, effort, and cost of creating the highly detailed image it illustrates will remain observable despite wheel and rotationally independant spinner motion.
(d) To provide a non-rotatable wheel ornament with a highly detailed image which can be chrome, gold, or powder-coat plated, as well as qualifying the image for the precise process of airbrushing.
(e) To provide a non-rotatable wheel ornament which will show evidence of its creativeness to be novel by being comprised purely of highly detailed aesthetic asymmetrical or symmetrical artist composed images.
(f) To provide a non-rotatable wheel ornament constructed from a three step process, permitting the image to exhibit natural expression.
(g) To provide a non-rotatable wheel ornament for a rotationally independant wheel spinner comprised of highly detailed illustrations that rotationally independant wheel spinner manufacturers do not supply.

Still further objects and advantages will become apparent from a study of the following description and accompanying drawings.

### SUMMARY

The objective of the present invention is to implement an ornamental device including; a partially threaded spindle adapter for establishment within the centemost threaded portion of a rotationally independant wheel spinner of an automobile wheel; and a counterbalance containing a bearing and an ornamental member having a image casted thereupon comprising a housing formed within the rear portion of the ornamental image for mechanically coupling with the counterbalance; whereby upon wheel and rotationally independant wheel spinner rotation, to coordinately revolve the spindle adapter mounted on the rotationally independant wheel spinner, the ornamental image will be situated vertically constantly relative to the rotation of the combined car wheel and rotationally independant wheel spinner to thereby display the decoratively formed image vertically, plainly and perceivably.

### DRAWINGS--FIGURES

FIG. 1 is a pespective left side-view of the invention.

FIG. 1-1 is a perspective rear-view of the invention.

FIG. 2 is a perspective side-view of spindle adapter.

FIG. 3 is a perspective isometric view of sealed bearing.

FIG. 3-1 is a cross-sectional view of sealed bearing.

FIG. 4 is a perspective front-view of counterbalance.

FIG. 4-1 is a perspective isometric view of counterbalance.

FIG. 5 is a perspective isometric view of washer

FIG. 7 is a perspective front-view of snap ring.

FIG. 7-1 is a perspective isometric view of snap ring.

FIG. 8 is a perspective front-view of the rotationally independant wheel spinner constructed in accordance with the invention of FIG. 1.

FIG. 8-1 is a cross-sectional exploded view of the rotationally independent wheel spinner in accordance with the invention of FIG. 1

FIG. 8-2 is a cross-sectional view of the rotationally independant wheel spinner in accordance with the invention.

FIGS. 9 to 9-7 show front and rear views of ornaments having various combinations of counterbalance housings.

FIGS. 10 to 10-2 show front and isometric views of a round counterbalance and weight.

### DRAWINGS--REFERENCE NUMERALS

| | |
|---|---|
| 24 ornament | 24A counterbored hole |
| 24B counterbored hole | 24C counterbored hole |
| 25A screw | 25B screw |
| 25C screw | 26 counterbalance housing |
| 26A alt. counterbalanc housing | 26B alt. counterbalanc housing |
| 26C alt. counterbalanc housing | 26D alt. counterbalanc housing |
| 28 counterbalance rest | 30 spindle adapter |
| 30A threading | 30B flange |
| 30C nut | 30D shaft |
| 30E snap-ring groove | 30F face |
| 32 bearing assembly | 32A large enclosure |
| 32B ball bearing | 32C small enclosure |
| 32L seal | 32R seal |
| 34 counterbalance | 34-1 alt. counterbalance |
| 34A threaded hole | 34B threaded hole |
| 34C threaded hole | 36 leadweight |
| 36A insert | 38 bearing housing |
| 40 bearing ridge | 42 washer |
| 54 snap ring | 54A hole |
| 54B hole | 64 nut |
| 64a threaded section | 68 wheel mount |
| 70 spinner assembly | 86 spinner mount |
| 86A threaded section | 86B threaded |
| 90 retainer | |

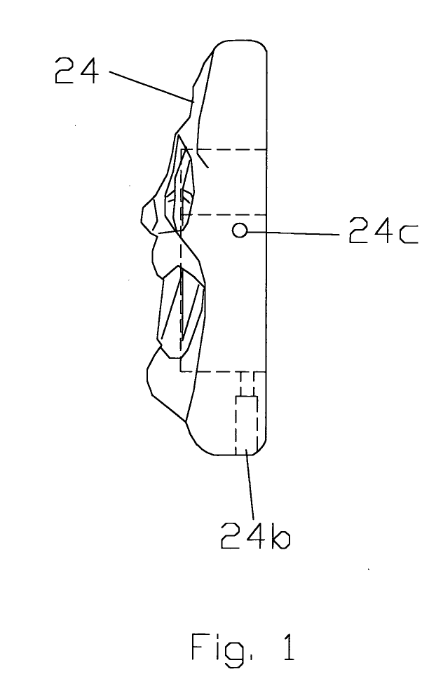

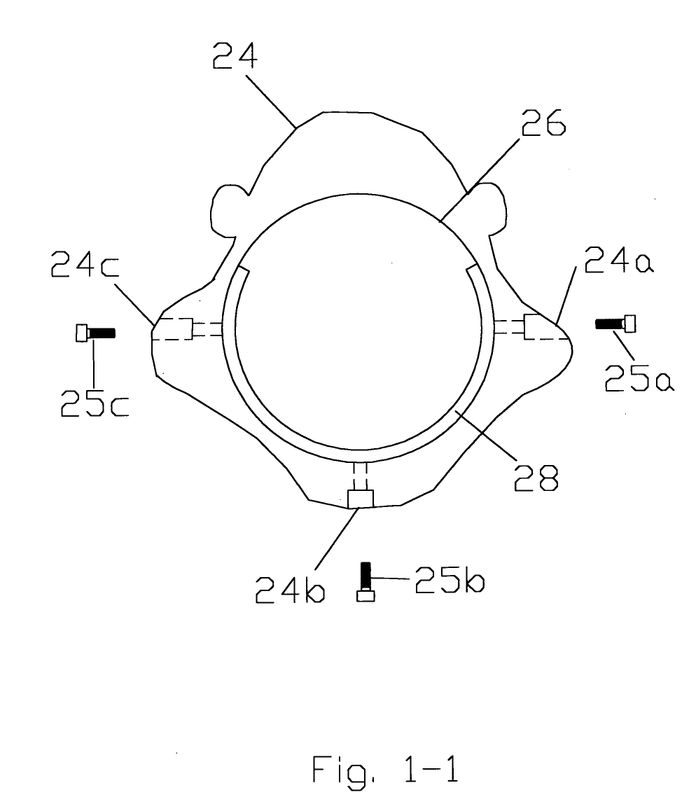

### DETAILED DESCRIPTION--FIGS. 1 to 1-1, 2, 3 to 3-1, 4 to 4-1, 5, 7 to 7-1

FIG. 1 shows a left-side view of the ornament of the invention. The front portion of wheel ornament, dressing, enhancer 24 consists of chrome or gold plated plastic material by electroforming. In the preferred embodiment, ornament 24 is composite plastic however, it can consist of any other material durable enough for the process of tank plating or electroform plating, such as polypropylene, polysulfone, polyethylene HD, polycarbonate, CPVC, Azdel, Acetyl Homopolymer, Extrusion Grade ABS, HIGH IMPACT ABS, high-density resin, aluminum, brass, bronze, potmetal, pewter, hardened stainless steel, nickel-base alloys, and cobalt-base alloys. Ornament 24 is constructed by sand casting, or injection casting method. Molds for forming the feature or image of ornament 24 can be hand made from clay or constructed using a computer numerical controlling (CNC) machine, but I prefer to combine the three methods by initially constructing the image from a hand made artist composed mold. Next, transferring the hand made mold to a computer-aided draft using a three dimensional scanner. Finally, programming the scanned dimensions into the (CNC) machine to create asymmetrical images, giving ornament 24 the lively appearance of natural expression. The outer dimensions of ornament 24 is typically 1 and ½″ to 2 and ½″ in thickness, and has overall dimensions roughly from 4″×4.5″ to 5″×5.5″. FIG. 1-1 shows a rear-view of ornament 24 containing a circular counterbalance housing 26 and a semi-circular counterbalance rest 28 consisting of a composite plastic material formed by casting. Counterbalance housing 26 is approximately 3.5″ in diameter and 1″ in thickness. Counterbalance rest 28 is approximately 3 and ⅜″ in diameter and ⅛″ in thickness. The outer portion of counterbalance housing 26 contains a plurality of counterbored holes 24A 24B 24C. Counterbored holes 24A 24B 24C range from ¼″ to ⅜″ in diameter being ⅛″ to ¼″ deep.

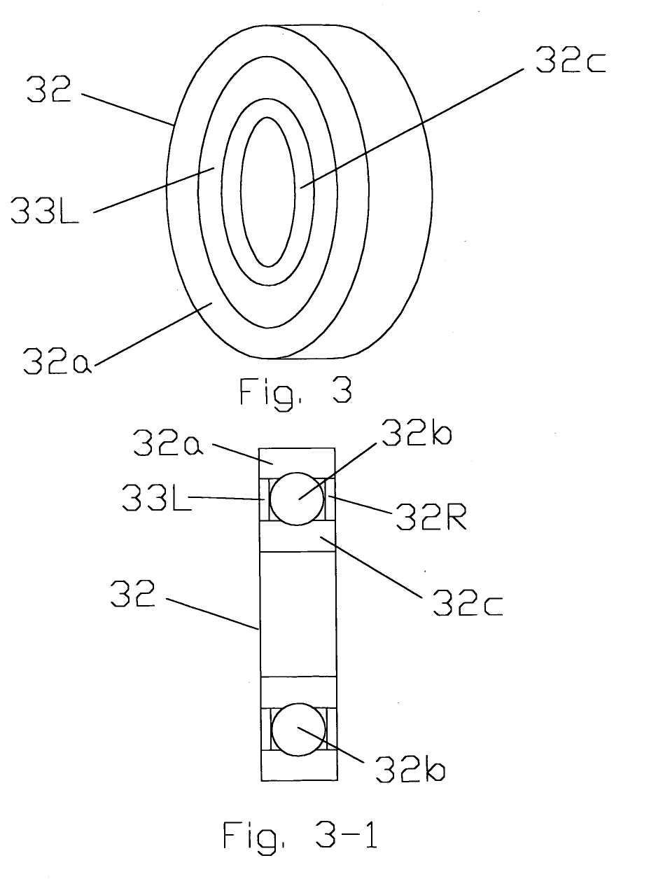

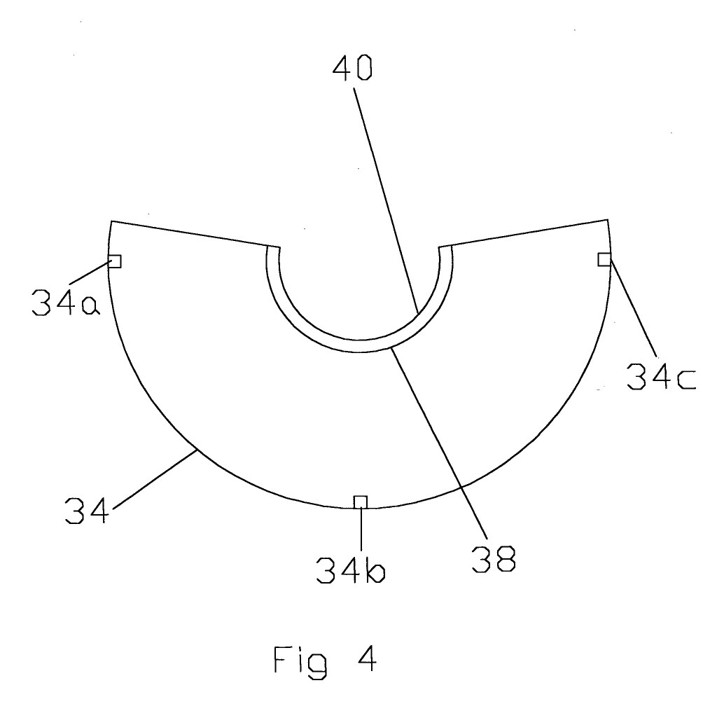

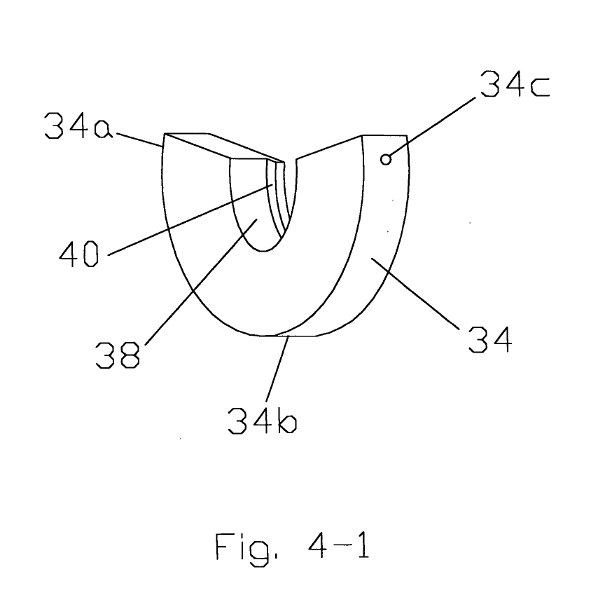

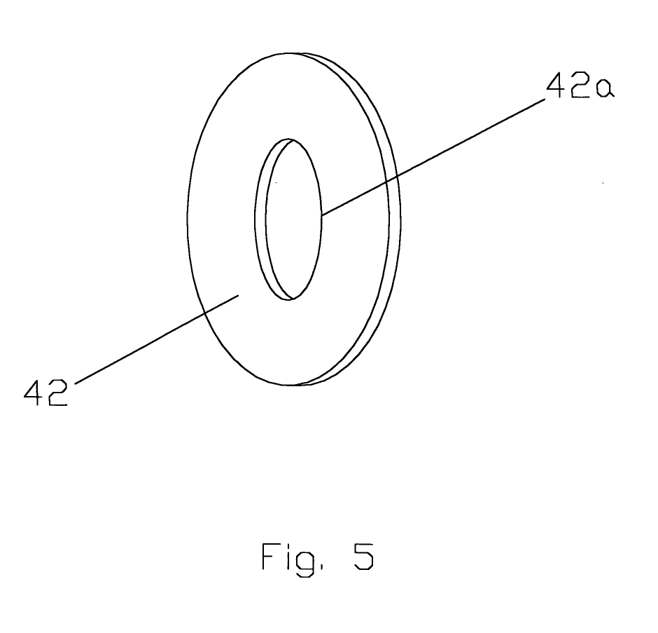

Counterbalance housing 26 and counterbalance rest 28 is joined to a counterbalance 34 (FIGS. 4 and 4-1). In the preferred embodiment, counterbalance 34 comprises a horse-shoe configuration and is machined from billet steel however, counterbalance 34 can be fabricated from various types of other heavy metals, such as bronze, brass, or cast-iron. Counterbalance 34 is approximately 3 and 11/32″ in diameter and ⅝″ to ⅞″ in thickness and has overall dimensions roughly from 3 and 11/32″×2″ to 5″×2.5″. Counterbalance 34 contains a plurality of threaded holes 34A 34B 34C evenly spaced along the outermost wall. Threaded holes 34A 34B 34C are approximately 8/64″ in diameter and typically ⅜″ in depth containing a tap size of 4-40 (Ten threads/inch). Threaded holes 34A 34B 34C joins a number of screws (25A 25B 25C). Screws 25A 25B 25C contains threading about the distal portion, which may be fine or coarse. The uppermost portion of screws 25A 25B 25C comprises circular shaped form, which may be countersunk or shanked. The base of screws 25A 25B 25C ranged from ⅛″- 5/16″ in thickness and approximately ½″-¾″ in length. The centermost portion of counterbalance 34 contains a bearing ridge 40 (FIGS. 4 and 4-1) formed by machining. Bearing ridge 40 ranges from 1 and 7/16″ to 2.5″ in diameter and 1/16″ in thickness. Bearing ridge 40 is adjacent to a bearing housing 38 formed by machining. Bearing housing 38 ranges from 1 and 7/16″ to 2.5″ in diameter and has a thickness of ⅝″. Bearing housing 38 joins a bearing assembly 32 (FIGS. 3 and 3-1). In the preferred embodiment, bearing assembly 32 is sealed however, the bearing assembly can consist of other types of bearing assemblies, such as sealed or unsealed roller bearings, or unsealed ball bearings. Bearing assembly 32 contains an enclosure (32A) and 32C comprised of machined steel encompassing a number of steel ball bearings 32B (FIG. 3-1). A circular rubber seal 32L and 32R accommodates the central opening between enclosures 32A and 32C by compression forming the sides of bearing assembly 32. The diameter of large enclosure 32A of bearing assembly 32 range from 1 and 27/64″ to 3″ and ranges from ½″ to 2″ in thickness. The diameter of small enclosure 32C of bearing assembly 32 range from ½″ to 1.5″ and ranges from ½″ to 2″ in thickness.

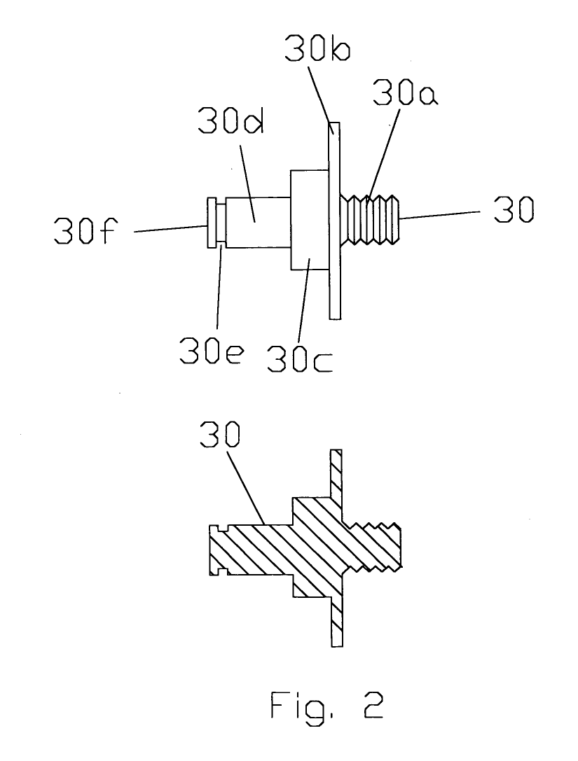

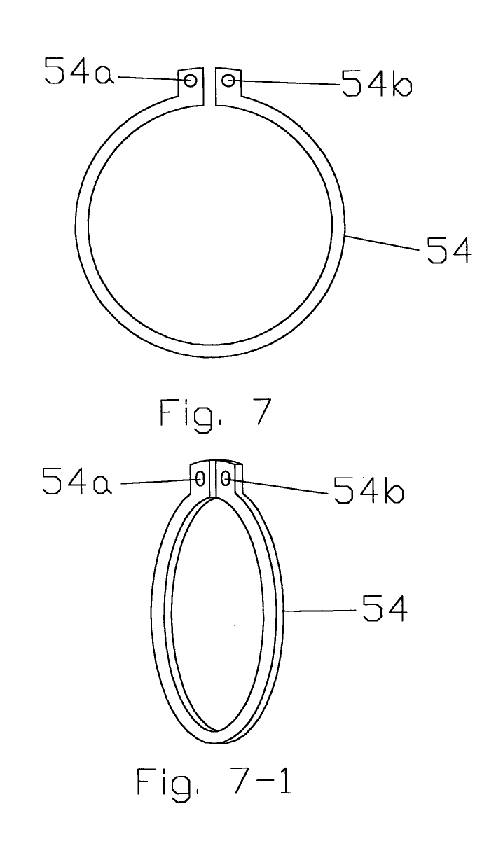

Small enclosure 32C of bearing assembly 32 joins a cylindrical spindle adapter 30 FIG. 2. In the preferred embodiment, spindle adapter 30, formed by machining, is constructed using machine steel however, it can be constructed using other types of high strength metals, such as hardened stainless steel, nickel-base alloys, cobalt-base alloys or high grade iron. The distal end of spindle adapter 30 contains a circular threaded portion (30A) adjacent to a disk-shaped flange 30B. A hexagon nut 30C adjoins flange 30B opposite of threaded portion 30A. Nut 30C contains a cylindrical shaft 30D comprising a circular snap-ring groove 30E following an adjoining circular face 30F. Snap-ring groove 30E joins a circular shaped snap ring 54 (FIGS. 7 and 7-1) containing a separation within the upper portion. Cylindrical shaft 30d joins a metallic circular washer (FIG. 5) following a metallic snap-ring 54 containing a plurality of holes 54A and 54B in the upper proximity of the separated portion.

Threaded portion 30A of spindle adapter 30 ranges from 1″-2″ in length being approximately 1″-1.5″ in thickness. Flange 30B ranges from ⅛″-½″ in thickness having an approximate diameter of 2″4″. Nut 30C may be configured to fit wrench sizes from 1″ to 13/16″ or 13 mm to 19 mm. Spindle shaft 30D ranges from ¾″ to 1″ in length and has a diameter of approximately ½″-1″. Snap-ring groove 30E contains a diameter of ⅝″-⅞″ and having a width of 1/16″-⅛″. Spindle adapter face 30F contains a diameter ranging from ¾″-1″ and is 1/16″-⅛″ in thickness. Washer 42 contains a diameter ranging from ½″ to 1′ in diameter and ⅛″ in thickness. Snap-ring 54 contains a diameter approximately ⅝″-⅞″. Holes 54A and 54B typically range from 1/16″-⅛″ in diameter.

### OPERATION--FIGS. 1 to 1-1, 2, 3 to 3-1, 4 to 4-1, 5, 7 to 7-1

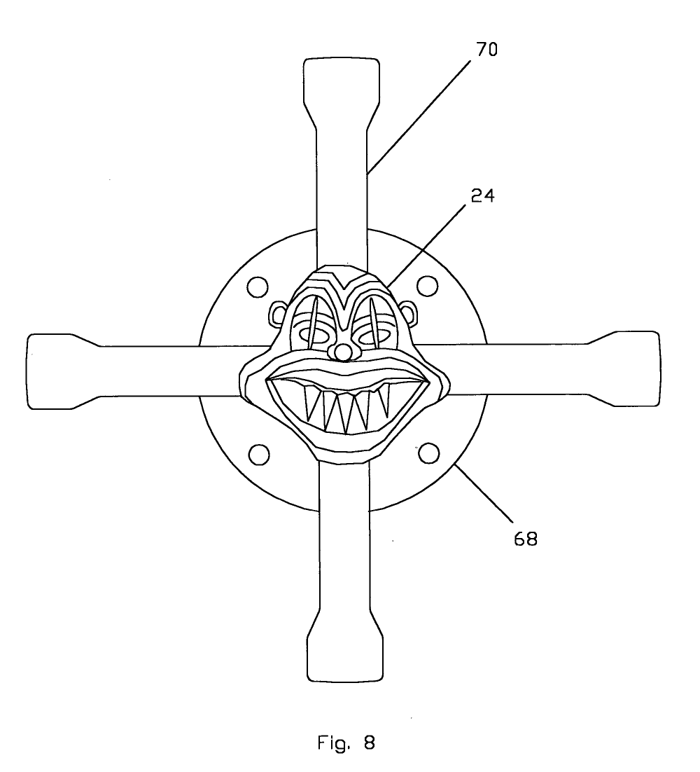

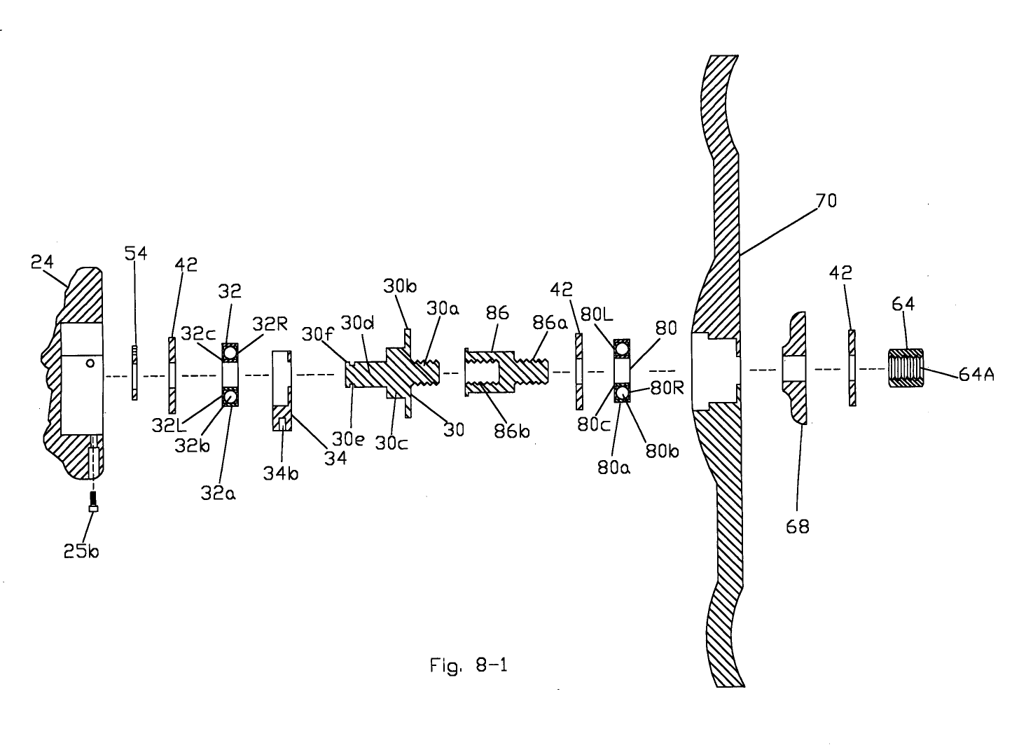

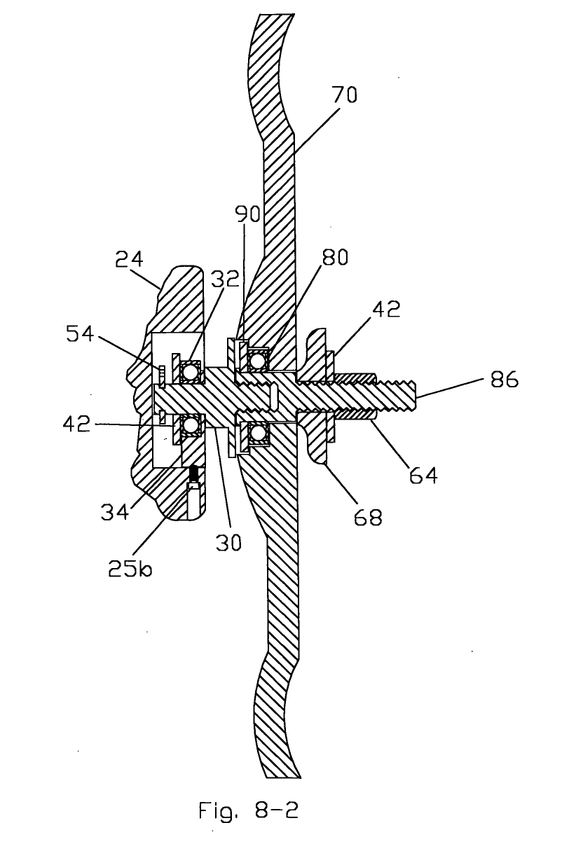

In operation ornament 24 is constructed for additional enhancement of present automoile, semi-trailers, boat carrying trailers and golf car wheels by illustrating personage or beastlike features, logos, trademarks, etc, while being non-rotatable upon wheel rotation for continuous observability as shown in FIG. 1. Housing 26 contains a plurality of counterbored holes 24A 24B 24C along the outer circumference for occupying screws 25A 25B 25C (FIG. 1-1). The central portion of housing 26 allows installation of a counterbalance 34 (FIGS. 4 and 4-1). The horse-shoe configuration of countebalance 34 is designed to accomodate the centermost region of a wheel permitting maximum stability. Counterbalance housing 26 (FIG. 1-1) includes a counterbalance rest 28 for stopping and stabilizing counterbalacne 34. Counterbalace 34 includes a plurality of threaded holes 34A 34B 34C (FIG. 4-1) for receiving screws 25A 25B 25C adjoining counterbalance housing 26 to counterbalace 34. The center portion of counterbalance 34 contains a bearing ridge 40 (FIG. 4-1). Bearing ridge 40 functions as a retainer and allows one-way entry for a bearing assembly. A bearing housing 38 is adjacent to bearing ridge 40 (FIG. 4-1). Bearing housing 38 is structured for placing and retaining a bearing assembly 32 (FIGS. 3 and 3-1) by compression fitting. FIG. 3-1 shows bearing assembly 32 comprising a rubber seal 32L and 32R for preventing the entrance of dirt and moisture within bearing assembly 32 and a plurality of ball bearings 32B confined between a large and small enclosure 32A and 32C permitting independant rotational motion of a spindle adapter 30 (FIG. 2). FIGS. 2, 8, 8-1 and 8-2 shows spindle adapter 30 comprising a spinner mount 86. Threaded section 30A contains an adjacent flange 30B to occupy the main opening of a spinner assembly 70. Flange 30B contains an adjacent nut 30C for fastening spindle adapter 30 within threaded section 86B of spinner mount 86. A shaft 30D extends nut 30C providing axial support of bearing assembly 32. Shaft 30D contains a snap-ring groove 30E for establishing a snap-ring 54. Snap-ring 54 retains entire bearing assembly 32 upon shaft 30D. A spindle adapter face 30F results in forming snap-ring groove 30E.

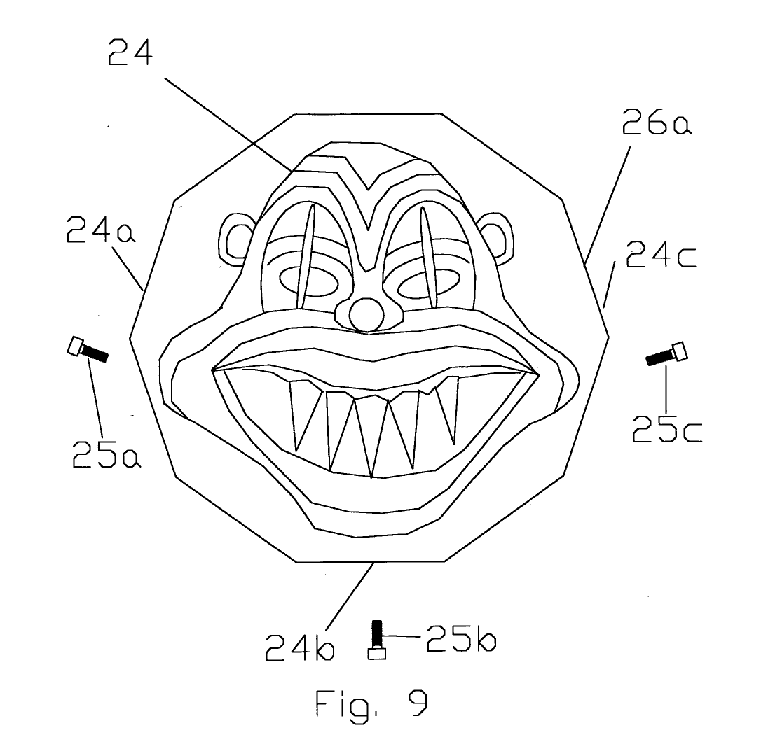

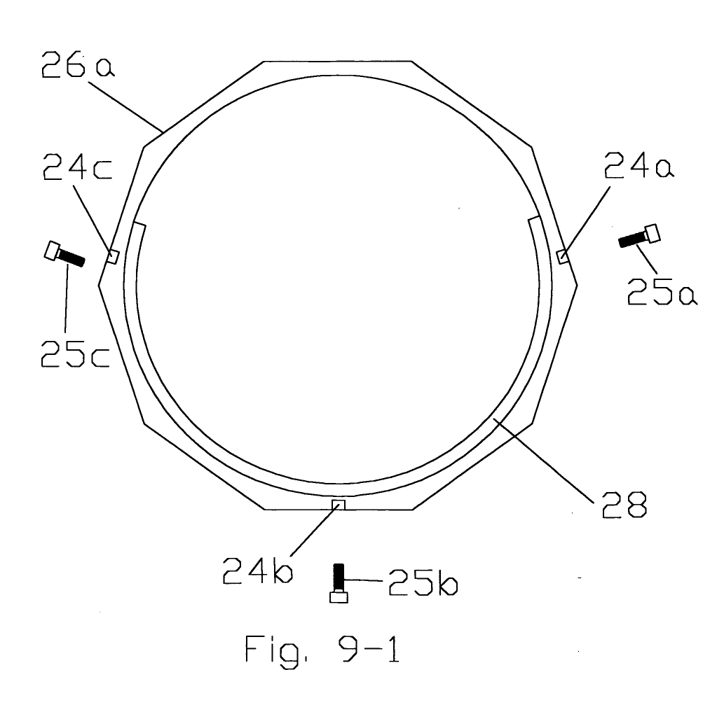

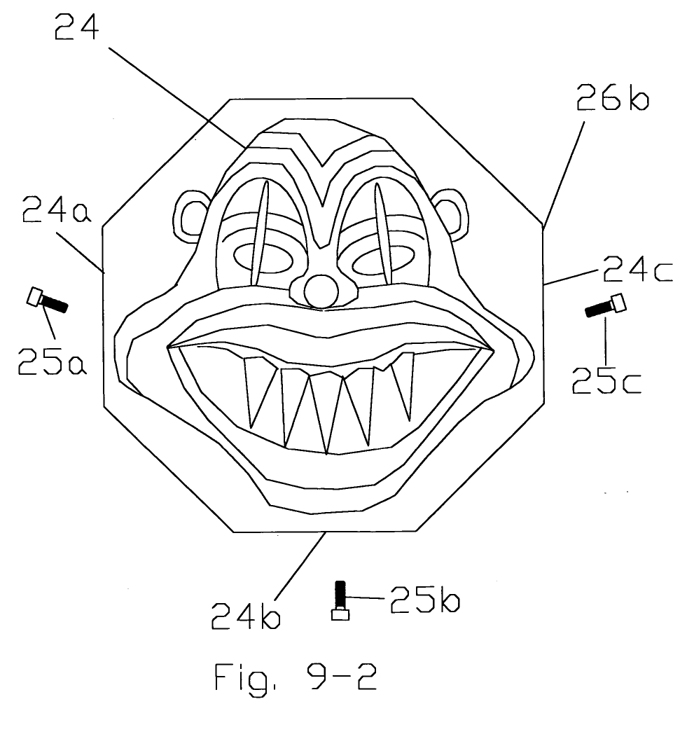

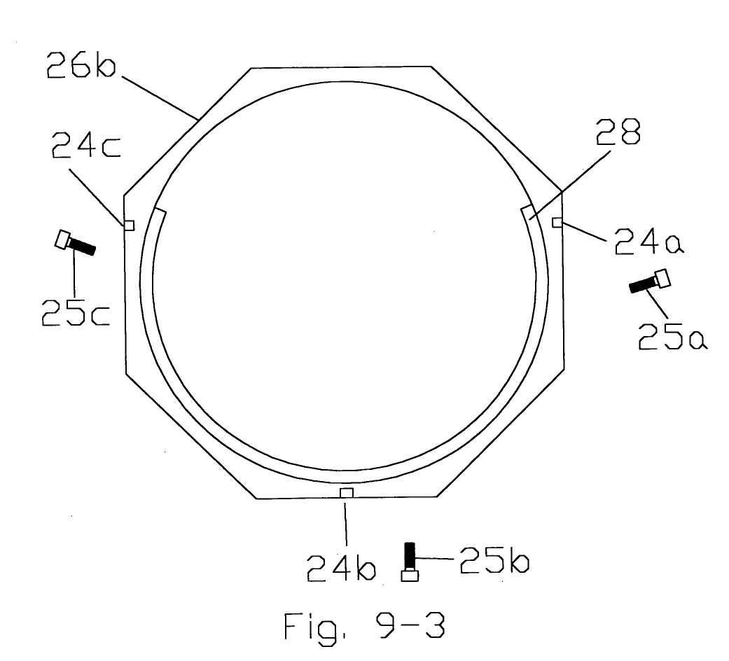

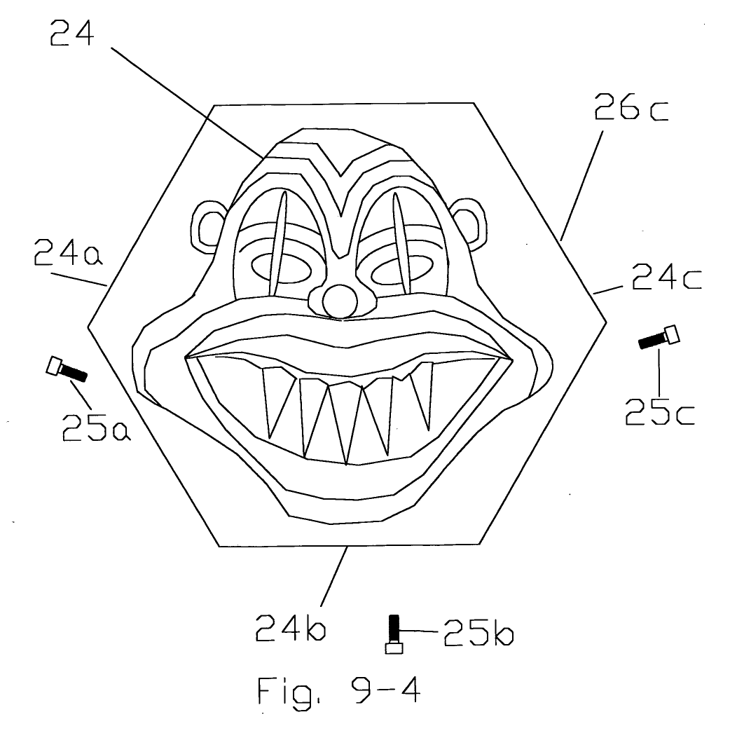

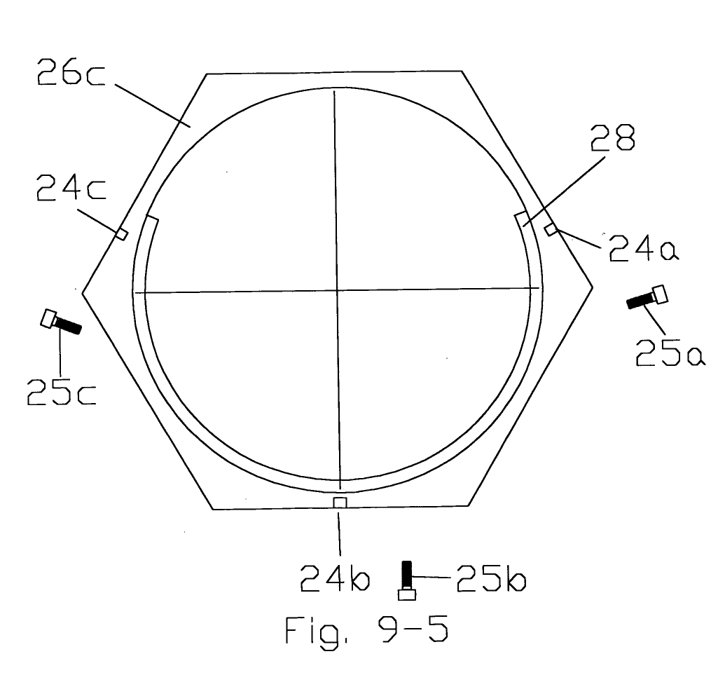

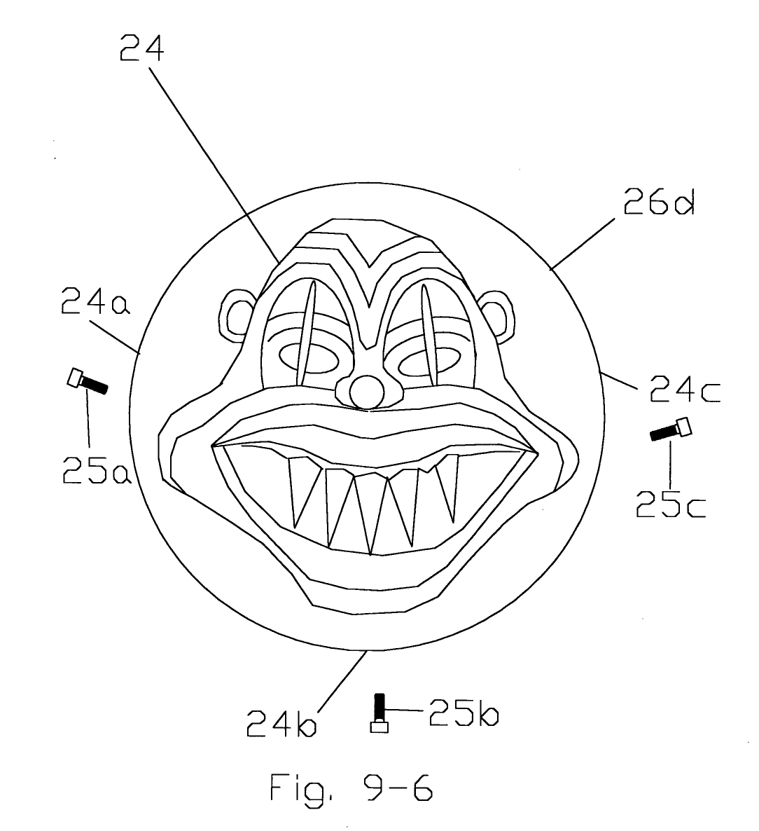

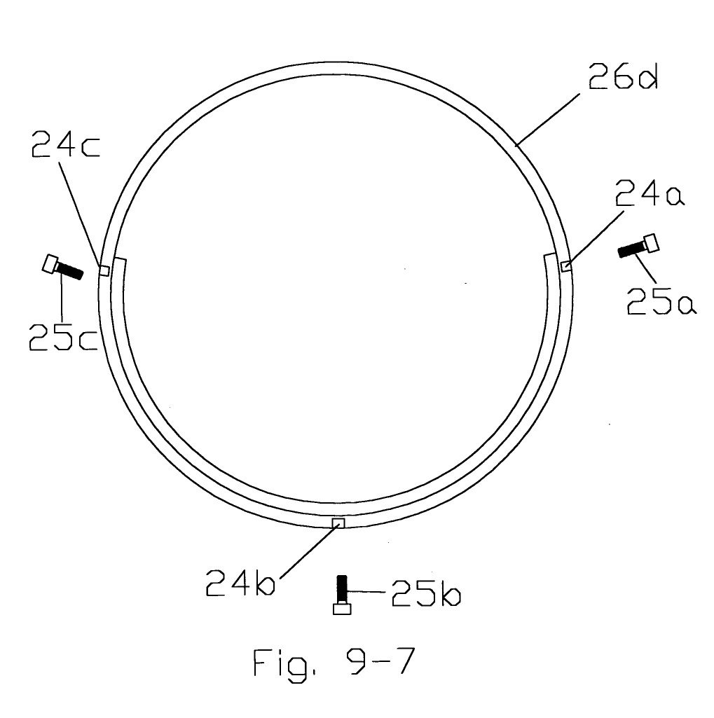

### FIGS. 9-9-7--ADDITIONAL EMBODIMENTS

Additional embodiments are shown in FIGS. 9 and 9-1 to 9-7; in each case the ornament 24 is shown attached. In FIGS. 9 and 9-1 the counterbalance housing has only ten sides with counterbored holes 24A 24B 24C; in FIGS. 9-2 and 9-3 it has only eight sides with counterbored holes 24A 24B 24C; in FIGS. 9-4 and 9-5 it has only six sides with counterbored holes 24A 24B 24C; and FIGS. 9-6 and 9-7 it is circular with counterbored holes 24A 24B 24C, all being formed simultaneously with ornament 24.

Counterbored holes 24A 24B 24C join screws 25A 25B 25C for joining counterbalance housing 26 with counterbalance 34.

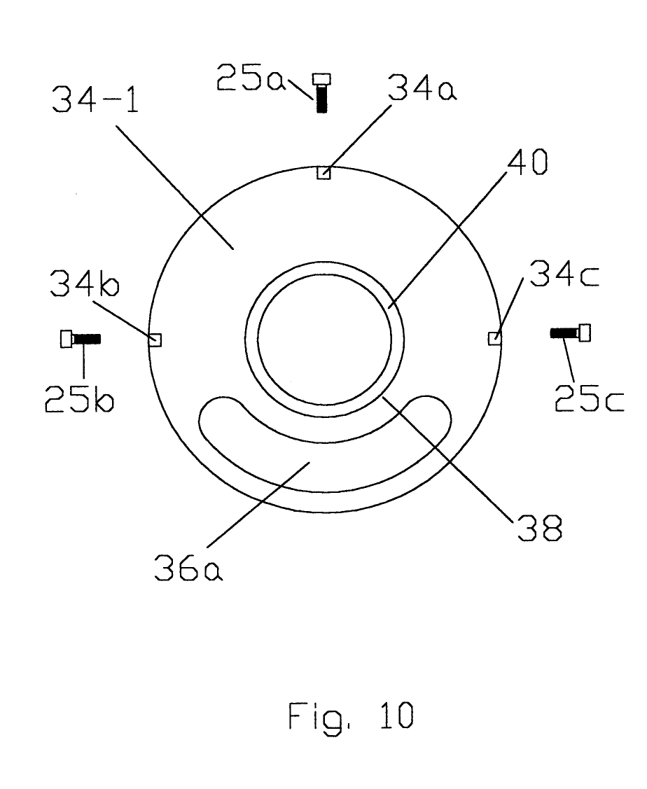

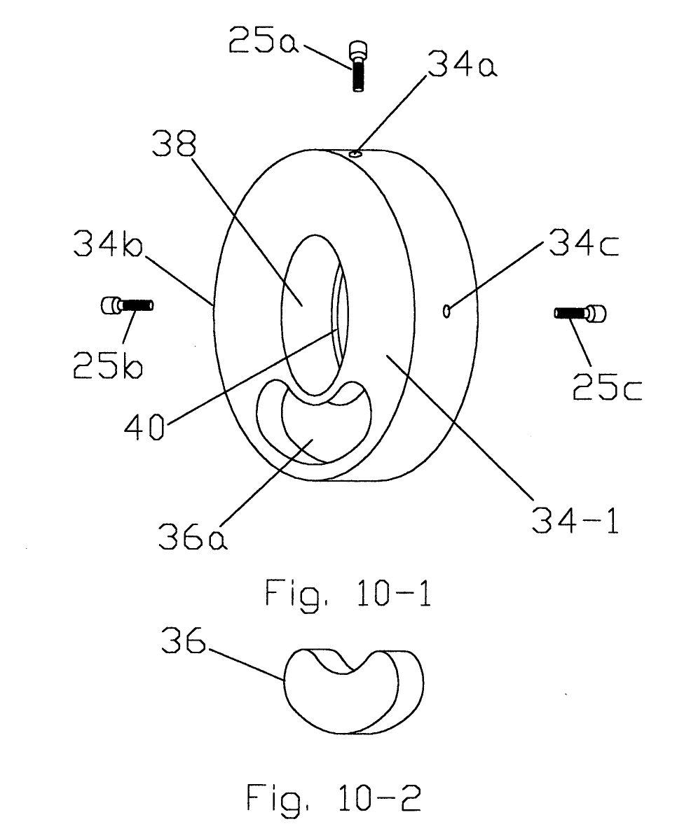

The operation of each of the embodiments of the present invention is next described. In operation, housing 26A (FIGS. 9-9-1) 26B (FIGS. 9-2) 26C (FIGS. 9-4) 26D (FIGS. 9-6,9-7) contain counterbored holes 24A 24B 24C for occupying screws 25A 25B 25C. Counterbored holes 24A 24B 24C range from ¼″-⅜″ in diameter being ⅛″-¼″ deep. Screws 25A 25B 25C contains threading about the distal portion which may be fine or coarse. The uppermost portion of screws 25A 25B 25C comprises circular shaped form which may be countersunk or shanked. The base of screws 25A 25B 25C ranged from ⅛″- 5/16″ in thickness and approximately ½″-¾″ in length. The central portion of housing 26A (FIG. 9-1) 26B (FIG. 9-3) 26C (FIG. 9-5) and 26D(FIG. 9-7) allows installation of counterbalance 34 (FIGS. 4 and 4-1) and counterbalance 34-1 (FIGS. 10 and 10-1).

### ALTERNATIVE EMBODIMENTS--FIGS. 10 to 10-2

There are other possibilities with regard to the relative configuration of counterbalance 34. With respect to FIGS. 10 to 10-1 counterbalance 34-1 is constructed as an entire circular portion containing counterbored holes 24A 24B 24C. The central portion of counterbalance 34-1 utilizes bearing ridge 40 and bearing housing 38 and a counterbalance insert 36A. Insert 36A joins a leadweight 36 comprised of lead however, leadweight 36 may consist of any other weighted metal material such as brass or bronze.

The operation of each of the alternative embodiments of the present invention is next described. In operation, counterbalance 34-1 consists of an entire piece of material (FIGS. 10 and 10-1) for fully occupying counterbalance housings 26 26A 26B 26C and 26D. counterbalance 34-1 is machined from billet steel however, counterbalance 34-1 can be fabricated from various types of other heavy metals, such as bronze, brass, or cast-iron. Counterbalance 34-1 is approximately 3 and 11/32″ in diameter and ⅝″-⅞″ in thickness and has overall dimensions roughly from 3 and 11/32″×3″ and 11/32″ to 5″×5″. Counterbalance 34-1 contains a plurality of threaded holes 34A 34B 34C evenly spaced about the outermost wall. Threaded holes 34A 34B 34C are approximately 8/64″ in diameter and typically ⅜″ in depth containing a tap size of 4-40 (Ten threads/inch). Threaded holes 34A 34B 34C joins a number of screws (25A 25B 25C). Screws 25A 25B 25C contains threading about the distal portion which may be fine or coarse. The uppermost portion of screws 25A 25B 25C comprises circular shaped form which may be countersunk or shanked. The base of screws 25A 25B 25C ranged from ⅛″- 5/16″ in thickness and approximately ½″-¾″ in length. Insert 36A is ½″ in width and 2 and ⅜″ in length and ½″ in thickness. Leadweight 36 (FIG. 10-2) is ½″ in width and 2 and 11/32″ in length and ½″ in thickness.

### ADVANTAGES

From the description above, a number of advantages of my non-rotatable ornament for rotationally independant wheel spinners become evident:
(a) Producing a non-rotatable ornament for rotationally independant wheel spinners would maximize the enhancement of their present appearance.
(b) Combining the illusional effects of a rotationally independant wheel spinner with the graceful pendulum motion of a non-rotatable wheel ornamet would move custom wheels to an astonishing new level.
(c) To supply non-rotatable wheel ornaments with an endless selection of illustrations or features, ranging from historic people, nature's animals, trademarks, logos, or personal requests.
(d) To produce a non-rotatable ornament for rotationally independent wheel spinners exhibiting the natural expression of art, by using artist composed molds to create asymmetrical images.

### CONCLUSIONS, RAMIFICATIONS, AND SCOPE

Accordingly, the reader will perceive that the present invention is not limited to automobiles. It is adaptable to wheels of semi-trailers, boat trailers, golf cars, all-terrain vehicles, and motorcycles of all types. Furthermore, the non-rotatable wheel ornament has the additional advantages in that

Many other variations are possible. For example, it allows the ability to construct an ornament that illustrates the countless images of beautiful animals that are in existence or extinction to images of self portraits, as well as images of those who are known legends and heroes in western society or globally such as images of Presidents, or famous people of Religions also, Musicians, Sports Players, Actors, Actresses, Artists, and images of passed loved ones.

It permits production of ornaments consisting of metal rather than plastic material.

It allows the counterbalance housing to be constructed to correlate the design of adjoining wheel. For example, if the wheel's design is comprised of five spokes, the housing may be designed to match.

It allows the elimination of the bearing assembly for placement of a bushing, to provide support of the device while freeing it from the rotationally independantly wheel spinner.

It admits the ornament and counterbalance to be constructed simultaneously having the counterbalance within the lowermost region of the ornament.

It permits the elimination of the spindle adapter to utilize a standard bolt for adjoining the ornament and the rotationally independantly wheel spinner.

It allows the elimination of the spindle adapter for use of a standard bolt to adjoin the ornament to the present center caps of rotationally independently wheel spinner.

It allows potentiality for improvement by placing a spring loaded ring within the counterbalance housing thereby increasing stability.

It permits the use of rhinestones to maximize the ornament's detailed features.

Although the above description contains many specificities, these should not be construed as limitations on the scope of the invention, but rather as an exemplification of one preferred embodiment thereof. For example, the ornamental section can be comprised of logos, trademarks, letters, numbers, or any feature requested thereon.

Accordingly, the scope of the present invention should be determined not by the embodiments illustrated, but by the appended claims and their legal equivalents.

I claim:

1. An ornament means mountable onto a rotationally independant wheel spinner of a vehicle wheel comprising:
an adapter means for removably joining a central portion of a spinner assembly, thereby axially aligning said adapter means with said spinner assembly;
a bearing supported by said adapter means,
a counterbalance supported by said bearing, the counterbalance having means for including a number of apertures located therein; and
a housing means for coupling said counterbalace posteriorly therein a composed ornamental image; and
a prominent section of said housing contains means for composing said ornamental image;
a bearing assembly supported by the spindle adapter, the bearing assembly configured to prohibit rotational motion between the spinner assembly and said ornamental image;
whereby said ornamental image remains vertical and observable continously as the vehicle is in motion, furthermore, the configuration of said ornamental image naturally displays pendulum dynamics as the vehicle moves

2. The ornamental means of claim 1 wherein said adapter means comprises a plurality of threads radially circling a distal end thereby coaxially joining said adapter means therein said central portion of the spinner assembly.

3. The ornamental means of claim 2, further including a radially centralized spindle thereby providing support for a central opening of said bearing.

4. The ornamental means of claim 2, further including a circular groove configured to encompass a snap ring.

5. The ornamental means of claim 3 wherein said spindle supports said central opening of said bearing thereby prohibiting rotary motion of said ornament as the vehicle progresses.

6. The ornamental means of claim 1 wherein said counterbalance comprises a circular housing configured to retain said bearing.

7. The ornamental means of claim 6, further including a circular ridge configured to prevent the counterbalance from escaping the bearing.

8. The ornamental means of claim 6, further including a plurality of threaded holes about the peripheral suface thereby allowing a screw for mechanically coupling said housing with the counterbalance.

9. The ornamental means of claim 1, wherein said ornamental image comprises a circular opening posteriorly for having said counterbalance.

10. The ornamental means of claim 9, further including a semicircular ridge configured within said posterior section of the ornamental image functioning as a rest for said counterbalance.

11. The ornamental means of claim 9, further including a plurality of counterbored openings thereby allowing the placement of said screw thereby mechanically coupling the housing and said counterbalance.

12. The ornamental means of claim 1 wherein said prominent section of said housing contains said composed ornamental image thereby displaying a design, brand name, label, emblem, and symbol.

13. The ornamental means of claim 12 wherein said composed ornamental image is comprised of skilled artistry.

14. A method for casting a wheel ornament from an artist composed image, comprising:
(a) providing a drawing containing skilled artistry thereby exhibiting natural expression.
(b) manually forming a sculpted mold from said composed drawing.
(c) transferring specifications of said sculpted mold into a computer numerical controlling machine format.
(d) programming said format into a computer numerical controlling machine, whereby said computer numerical controlling machine fabricates an injection mold.
(e) Injecting said injection mold thereby casting a wheel ornament duplicating the natural expression of said sculpted mold.

15. The method of claim 13 wherein said wheel ornament is comprised of a composite plastic material.

16. The method of claim 13 wherein said composite plastic is electroplated.
